(19) United States
(12) Patent Application Publication
(10) Pub. No.: US 2007/0068685 A1
(43) Pub. Date: Mar. 29, 2007

(54) METHOD AND APPARATUS FOR REMOVING OIL SPILLS AND EXTINGUISHING FIRES

(75) Inventor: Brian ARNOTT, Tomahawk, WI (US)

Correspondence Address: GODFREY & KAHN S.C., 780 NORTH WATER STREET, MILWAUKEE, WI, 53202, US

(73) Assignee: Glass Plus LLC

(21) Appl. No.: 11/559,970

(22) Filed: Nov. 15, 2006

Related U.S. Application Data
(63) Continuation-in-part of application No. 10/711,328, filed on Sep. 10, 2004, now Pat. No. 7,168,500.
Application No. 10/711,328 is a continuation-in-part of application No. 10/709,172, filed on Apr. 19, 2004, now Pat. No. 7,041,221.

(51) Int. Cl. A62C 3/00

(52) U.S. Cl. 169/47; 169/30

(57) ABSTRACT

The present invention provides methods, compositions and apparatus for removing oil and extinguishing fires using glass particles including crushed glass and fiberglass from an oil containing or fire containing surface. The fire containing surface can be any surface but in particularly desired embodiments the fire containing surface is a water surface, earthen surface, a mixture of earth and water or any surface that will hold a flammable substance. When the flammable substance is oil, the application of glass particles adsorbs oil and accretes into a mass sinking below the fire or oil containing surface. If greater floatation is desired, glass fibers can be added. The invention is particulary amendable to use with oil fires and magnesium fires and allows remediation of oil adsorbed to the glass surface. The invention also provides an apparatus for extinguishing fires from a surface by discharging glass particles over the oil or fire containing surface.

### RELATED APPLICATIONS

The present application is a continuation-in-part of U.S. patent application Ser. No. 10/711,328, filed on Sep. 10, 2004, which is a continuation-in-part of U.S. patent application Ser. No. 10/709,172, now U.S. Pat. No. 7,041,221, filed on Apr. 19, 2004 each of which is incorporated herein by reference for all purposes.

### TECHNICAL FIELD

The present invention generally relates to removal of hazardous liquid spills and extinguishing fires. Specifically, the invention relates to methods and apparatus for removing oil and corrosive liquid spills and extinguishing fires using crushed glass.

### BACKGROUND

Numerous methods and apparatus for removal of hazardous spills such as flammable and corrosive liquids and extinguishing fires are well known and established in the art.

In recent years there has been an ever increasing awareness of the devastating environmental damage that can be caused by oil spills and fires. It is well recognized that an extremely important aspect of minimizing damage from an oil spill and fire is the prompt containment and collection of the spilled oil and containment of fire. Effective collection of spilled oil ideally involves the absorption of oil in some absorption medium that can be easily raked or otherwise picked up from the surface upon which the oil has spilled. Nevertheless, despite intensive research and testing, the only absorption substances which are at all suitable for use in cleaning up oil spills involve significant defects or difficulties. Furthermore, none of the methods used for cleaning up oil spills can be used to put out oil fires and vice versa, methods for putting out oil fires cannot be used for cleaning up oil spills. Thus, in the instance of an environmentally hazardous and toxic catastrophe such as an oil spill, remedial efforts must first focus on the most immediate response, such as putting out a fire before the process of cleaning up a spill can even begin.

Some conventional oil absorbents currently in commercial use are made from polypropylene. Polypropylene absorbs hydrocarbons but is hydrophobic. That is, it is water repellent. However, polypropylene has a limited oil absorbing capacity, and is not at all biodegradable. Also, polypropylene is quite expensive to use in the large quantities necessary to deal with major oil spills. Other methods for oil removal include using absorbents containing polyethylene films, magnetic materials in combination with polyurethane, such as polyurethane containing iron powder, magnetic separation with magnetite and maghemite, acoustic energy, ultrasonic energy, in-situ combustion of oil, polyether containing isocyanate end groups, solidifiers, demulsifying agents, surface washing agents and dispersants combination polymers such as viscose rayon, polyamide fibers and small rubber adhering to the fibers.

Yet other efforts require using fish scale powder or biosurfactants such as rhamnolipid as an environmentally friendly and economically viable remediation option. Efforts are also directed to finding other biodegradable oil absorbent materials suitable for cleaning up oil spills. Other biodegradation agents including micro-organisms capable of degrading hydrocarbons, liposomes, bacterial mixtures, enzymes, or fertilizers have been proposed, however, only some of these are commercially viable. For example, peat moss has been used for this purpose. However, in the form in which it is obtainable commercially, peat moss contains a significant amount of impurities such as a sand and carbon. Also, peat moss does not float on water well and is limited in its absorption capacity for oil. For example, one pound of peat moss will absorb about five pounds of oil. In addition, peat moss is not totally biodegradable. Organoclay made by a reaction of smectite clay and quaternary ammonium compound have also been used as oil spill remediation agents.

Another substance which has been tested for its oil absorbent capacity in cleaning up oil spills is a seaweed-based product that is normally sold as a soil conditioner. This product is sold under the registered trademark, AFRIKELP, and is comprised of a blend of selected brown seaweeds found off the southern coast of the African continent. However, this product is rather expensive and has a limited oil absorption capability. Biodegradable remedies for removing oil from spills also include using coconut coir pit, dried corn cobs in their natural state or raw cotton. Other chemical dispersants, gelling agents, inorganic clays, foam plastics, booms and skimmers are also well known in the art.

Most of the existing materials are either manufactured for remediation of oil spills and thus have real costs associated with the manufacture or require harvesting which may be equally labor intensive. Further, existing art does not teach methods and apparatus with a concomitant effect of recycling undesirable waste, which would otherwise occupy landfills.

Furthermore, when oil spills are associated with fire, additional materials and chemicals are required either for extinguishing fire or removing oil from surfaces such as oceans and rivers. But such materials and chemicals are not useful for both extinguishing fires and removing oil spills.

Generally, there are four different types or classes of fire extinguishers, each of which extinguishes specific types of fire. Class A Extinguishers are used to put out fires in ordinary combustibles, such as wood and paper. Class B Extinguishers are used on fires involving flammable liquids, such as grease, gasoline, oil, etc. Class C Extinguishers are suitable for use on electrically energized fires. Class D Extinguishers are designed for use on flammable metals and are often specific for the type of metal in question. Class K Extinguishers are designed for use on cooking media, such as fats, grease and oils in commercial cooking such as restaurants. A site susceptible to different kinds of fire or fire burning as a result of different fuel sources, requires numerous fire extinguishers to achieve the same result of reducing or putting out fires resulting from different fuel sources.

Due to their use on fires having different fuel sources the above listed classes of extinguishers require different methods and mixtures of ingredients for putting out fires. For example, class A fire extinguishers can use dry or wet ingredients. Ingredients used in Class ABC dry fire extinguishers include: monoammonium phosphate; ammonium sulphate; mica; fullers earth; silicone oil; calcium carbonate and amorphous silica. While these compounds have been found effective in putting out fires inhalation of the ingredients is considered harmful and OSHA guidelines require respiratory protection. Class D fire extinguishers have ingredients including: sodium chloride, mica; attapulgite clay; mineralite; magnesium stearate; and amorphous silica (fumed). Class K extinguishers have a mixture of ingredients including: potassium bicarbonate; mica; attapulgite clay and silicone oil. In addition, other fire retardants used in extinguishing fires include, but are not limited to: sodium chloride, magnesium stearate, sodium bicarbonate, magnesium aluminum silicate, diammonium phosphate, monoammonium phosphate and alkyl acid phosphates which may have up to 10 carbon atoms. In addition, the ingredients included in these extinguishers may include various pigments. Further, foam components are also used in fire extinguishers. Such foam components including but not limited to diethylene glycol monobutyl ether, tertiary butyl alcohol, hexylene glycol, ethylene glycol.

Accordingly, the need exists for a fire extinguisher or apparatus that can be used to put out fires resulting from multiple fuel sources and that may occur in a variety of environments so as to effectively put out the fire while also aiding in the remediation and clean up of the fuel. With these requirements in mind it is desirable to obtain a composition and method that is capable of putting out fires resulting from most fuel sources, allows for clean-up and remediation of the fuel and that also uses discarded recyclable materials, with minimal cost of processing and biohazard for wildlife. Further the need exists for a fire extinguisher or extinguishing method that not only replaces multiple fire extinguishers and chemicals but also allows for the absorption/adsorption of oil and/or other hazardous liquids and also allows for the remediation or reuse of the spilt hazardous liquid after cleanup. Further, another desirable characteristic of such a method and/or composition would be that it has no reaction with acid compounds that may be released by the fire or spill.

### SUMMARY OF THE INVENTION

The present invention provides methods, compositions and apparatus for removing oil and extinguishing fires using glass particles including crushed glass and fiberglass from an oil containing or fire containing surface. The oil or fire containing surface can be any surface but in particularly desired embodiments the fire surface is a water surface, earthen surface, a mixture of earth and water or any surface that will hold a surface layer of oil. The application of glass particles adsorbs oil and accretes the oil/glass particles into a mass which sinks below the fire or oil containing surface. If greater floatation is desired, fiberglass, glass fibers and spun glass can be added. The invention is particularly amendable to use with oil fires and magnesium fires and allows remediation of oil adsorbed to the glass particle. The invention also provides an apparatus for extinguishing fires from a surface by discharging glass particles over the oil or fire containing surface. Of course, it should be appreciated that the glass particles can be mixed with other fire retardants already known, such as, for example, monoammonium phosphate; ammonium sulphate; mica; fullers earth; silicone oil; calcium carbonate; amorphous silica; sodium chloride, mica; attapulgite clay; mineralite; magnesium stearate; potassium bicarbonate; mica; attapulgite clay and silicone oil, diammonium phosphate, alkyl acid phosphates, sodium chloride, magnesium stearate, sodium bicarbonate, magnesium aluminum silicate, diethylene glycol monobutyl ether, tertiary butyl alcohol, hexylene glycol and ethylene glycol.

Accordingly, the present invention provides, in one preferred embodiment, a method of extinguishing fire from fire containing surfaces, comprising the step of applying glass particles to the fire containing surface wherein the glass particles form clumps with a fuel at the fire-containing surface and the fuel-glass clumps sink below the top surface; thereby reducing the intensity of the fire from the fire containing surface or effectively extinguishing the fire from the fire containing surface. Further, in this embodiment, the fuel can include, but is not limited to flammable compounds such as oil, magnesium, lightweight petroleum products and combinations thereof. In those aspects when the fuel is oil, the oil absorbed on the crushed glass is recyclable as petroleum-silica based product, water repellent, roof shingles, asphalt, fuel cake or fuel source. Further, in some preferred embodiments, the crushed glass is mixed with other compositions useful in extinguishing fires including, but not limited to:

In one preferred embodiment the surfaces may include water, saline water, earth, ground, dirt, mud, gravel, concrete, land surrounding water bodies, land beneath water bodies, sand, seashore, estuary, bay, gulf, oceans, lakes or rivers.

In some preferred embodiments of the present invention, the glass particles are glass fibers, crushed glass or mixtures thereof. When crushed glass is used in removing oil, the crushed glass is recyclable glass; however, non-recyclable glass may also be used. Also preferably, crushed glass includes colored glass; however, other non-colored glass may also be used. This crushed glass may be prepared using an impact crusher, hammer mill, cone crusher or a roller crusher. Preferably, the recyclable glass is crushed using roller crusher. The crushed glass is pre-crushed and pre-screened, as necessary. The crushed glass is pre-screened through a mesh, which may include an inch mesh, a combination of double or triple deck screens or at least two meshes. Once pre-screened through the mesh, the crushed glass is dried to substantially remove moisture from the glass particles. In some embodiments the glass particles are heated to at least 100° F., in a preferred embodiment, or to at least 350° F. in another preferred embodiment. However, in some embodiments, when the glass is crushed by an impact crusher or a hammermill crusher, the glass does not need to be dried. Subsequently, the crushed glass is screened through about at least a 20 mesh in a preferred embodiment, or through a 30 mesh in another preferred embodiment, or through a 40 mesh, in yet another preferred embodiment. In still another preferred embodiment, the crushed glass is screened through up to a 150 mesh screen. However, it should be appreciated that in some instances the crushed glass may be a combination of mesh sizes from 20 to 150.

In some preferred embodiments, the oil adsorbed on the glass particles can be further recycled as petroleum silica based product, water repellant product, roof shingles, asphalt, fuel cake or fuel source.

In yet another preferred embodiment, the present invention also provides a method of removing a hazardous liquid from a hazardous liquid-containing surface, comprising the step of applying glass particles to the surface, whereby the quantity of hazardous liquid is reduced from the surface. In various exemplary embodiments, the glass particles are glass fiber or crushed glass. When the glass particles are crushed glass, the glass is pre-crushed, pre-screened, dried and screened prior to application on the surface. Preferably, the glass particles are dried to temperature of at least 100° F. In other embodiments, the glass particles are heated to about 200-350° F. to dry. In various exemplary embodiments, the glass particles are screened from about between 20 to 150 mesh.

In a preferred embodiment, the present invention also provides an apparatus for removing a hazardous liquid from a hazardous liquid-containing surface, comprising an application member and a collection member. The application member is capable of applying glass particles on the hazardous liquid from a hazardous liquid-containing surface, whereas the collection member is capable of collecting hazardous liquid absorbed on the glass particles. In this embodiment, the hazardous liquid can be any liquid that adheres to glass particles. However, in preferred embodiments, the hazardous liquid can be oil or corrosive liquids. Further, when the glass particles are crushed, the crushed glass is pre-crushed, pre-screened, dried and screened prior to applying the glass particles on the surface. Preferably, the crushed glass is screened with at least about a 20 mesh in other preferred embodiments the glass is screened with a 30 mesh, a 40 mesh or up to a 150 mesh. In some exemplary embodiments, the crushed glass is of varying sizes from 20 to 150. In other exemplary embodiments, the glass particles are dried so as to substantially remove moisture from the glass particles. In some embodiments, the glass particles are dried to a temperature of about 100° F. However, it should be appreciated that the purpose of drying is to remove substantially all water moisture and thus any drying at whatever temperature that is adequate to remove such moisture is within the scope of the invention. Further, when the hazardous liquid is flammable such as, for example, oil, the oil absorbed on the crushed glass is recycled as petroleum-silica based product, water repellent, roof shingles, asphalt, fuel cake or fuel source. However, in other embodiments of the invention the hazardous liquid is a corrosive liquid such as, for example an acid like muriatic acid and hydrochloric acid, for example.

In another preferred embodiment, the present invention provides a method of preventing oil spills from a container having oil, comprising the step of surrounding the oil container at least in part with a layer of glass particles. When the glass particles are crushed, the crushed glass is pre-crushed, pre-screened, dried and screened prior to surrounding the oil container with crushed glass. Preferably, the crushed glass is screened with at least about a 20 mesh. However, in other preferred embodiments, when the glass is crushed it is screened through a 30 mesh, a 40 mesh or up to about a 150 mesh. In some exemplary embodiments, the crushed glass is a mixture of sizes ranging from about a 20 mesh to about a 150 mesh. Also in some preferred embodiments, the glass particles are dried so as to substantially remove moisture from the glass particles. In some preferred embodiments, the oil container is an underground oil storage tank.

In yet another aspect, the present invention provides an apparatus for extinguishing fire from fire containing surfaces. The apparatus comprises an application member, which is capable of applying glass particles on the surface. Preferably, the application member is an extinguisher cartridge. When the glass particles are crushed glass, the crushed glass is preferably pre-crushed, pre-screened, crushed, dried and screened prior to applying the crushed glass on the surface. The crushed glass is screened with about at least a 20 mesh and dried to a temperature adequate to substantially remove moisture from the glass particles. In some versions, the glass particles are heated to a temperature of at least about 100° F. Further, in some preferred embodiments, the glass particles are screened through a 30 mesh, a 40 mesh or up to a 150 mesh. The oil absorbed on the glass particles can be further recycled as petroleum silica based product, water repellant product, roof shingles, asphalt, fuel cake or fuel source.

Another aspect of this invention teaches a method of preventing fire in an oil container. The method comprises the step of surrounding the oil container at least in part with a layer of glass particles. When the glass particles are crushed, the glass is pre-crushed, pre-screened, crushed, dried and screened prior to surrounding the oil container with crushed glass. The crushed glass is screened with at least about a 20 mesh and is dried to a temperature about 200-350° F. However, in some embodiments, the glass is crushed to a 30 mesh, a 40 mesh or up to a 150 mesh. In some preferred embodiments, the oil container is an underground oil storage tank.

The present invention may be used in a multitude of situations where removal of hazardous wastes and fire extinguishing capabilities, either simultaneously or independently, are desired. Thus, the present invention should not be interpreted as being limited to application in removal of hazardous liquids, including, for example, oil from oil spills and/or extinguishing fires. For example, the invention herein described provides for improved methods of putting out fires resulting from any fuel source including such as highly flammable fuels as magnesium. In such instances, the composition and/or method would contain or clump up the fuel source and or acids and other compounds released by the fire and or spill and prevent them from being released into the atmosphere.

In sum, the present invention represents a significant improvement over the prior art in many ways, including using recyclable discarded material, and ease of use. These and other objects and advantages of the present invention will become apparent from the detailed description accompanying the drawings.

### BRIEF DESCRIPTION OF THE DRAWINGS

FIG. 1 is a diagram of a fire extinguisher according to one embodiment of the invention.

### DETAILED DESCRIPTION

The present invention provides methods, compositions and apparatus for removing hazardous liquids and extinguishing fires using glass particles including crushed glass and fiberglass from a hazardous liquid containing or fire containing surface. As disclosed herein, the hazardous liquid can be any liquid that is adsorbed to glass particles. In exemplary embodiments, the hazardous liquid is a flammable liquid, such as oil, ethyl ketone, naptha and the like, and/or a corrosive liquid including acids such as muriatic acid and hydrochloric acid. The hazardous liquid or fire containing surface can be any surface but in particularly desired embodiments the fire surface is a water surface, earthen surface, a mixture of earth and water or any surface that will hold a surface layer of oil. The application of glass particles adsorbs oil and accretes into a mass sinking below the fire or oil containing surface. The invention is particularly amendable to use with oil fires and magnesium fires and allows remediation of oil adsorbed to the glass surface. The invention also provides an apparatus for extinguishing fires from a surface by discharging glass particles over the oil or fire containing surface. Further, it should be appreciated that the glass particles can be mixed with other fire retardants already known, such as, for example, monoammonium phosphate; ammonium sulphate; mica; fullers earth; silicone oil; calcium carbonate; amorphous silica; sodium chloride, mica; attapulgite clay; mineralite; magnesium stearate; potassium bicarbonate; mica; attapulgite clay and silicone oil, diammonium phosphate, alkyl acid phosphates, sodium chloride, magnesium stearate, sodium bicarbonate, magnesium aluminum silicate, diethylene glycol monobutyl ether, tertiary butyl alcohol, hexylene glycol and ethylene glycol.

Before the present compositions and methods are described, it is understood that this invention is not limited to the particular methodology, protocols and glass types described, as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise. Thus, for example, reference to “a particle” includes a plurality of such particles and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference for the purpose of describing and disclosing the chemicals, cell lines, vectors, animals, instruments, statistical analysis and methodologies which are reported in the publications which might be used in connection with the invention. Nothing herein is to be construed as an admission that the invention is not entitled to antedate such disclosure by virtue of prior invention.

Definition List 1

| Term | Definition |
|---|---|
| Oil | Any petroleum based product naturally derived or |
| | synthetic, including crude oil, gasoline, diesel and |
| | paint thinners or any inflammable fluid or solid. |
| Glass particle | A preparation of glass in which the glass has at |
| | least one dimension that would allow the glass to |
| | pass through at least a 20 mesh screen, this |
| | includes crushed glass and glass fibers that, |
| | however long, may have a diameter small enough |
| | to fit through at least a 20 mesh screen. |

In addition, as used herein the terms adsorb and absorb are used interchangeably such as the oil absorbed from the surface is adsorbed to the glass particle.

Accordingly, the present invention provides, in one preferred embodiment, a method of extinguishing fire from fire containing surfaces, comprising the step of applying glass particles to the fire containing surface wherein the glass particles form clumps with a fuel at the fire-containing surface and the fuel-glass clumps sink below the top surface; thereby reducing the intensity of the fire from the fire containing surface, removing the fuel source from oxygen and effectively extinguishing the fire from the fire containing surface. Further, when the fuel is oil, the oil adsorbed on the crushed glass is recycled as petroleum-silica based product, water repellent, roof shingles, asphalt, fuel cake or fuel source.

In a preferred embodiment the surfaces may include water, saline water, earth, ground, dirt, mud, gravel, concrete, land surrounding water bodies, land beneath water bodies, sand, seashore, estuary, bay, gulf, oceans, lakes or rivers.

In some preferred embodiments of the present invention, the glass particles are glass fibers or crushed glass. When crushed glass is used in removing oil, the crushed glass is recyclable glass; however, non-recyclable glass may also be used. Also preferably, crushed glass includes colored glass; however, other non-colored glass may also be used. This crushed glass may be prepared using an impact crusher, hammer mill, cone crusher or a roller crusher. Preferably, the recyclable glass is crushed using roller crusher. The crushed glass is pre-crushed and pre-screened, as necessary. The crushed glass is pre-screened through a mesh, which may include an inch mesh, a combination of double or triple deck screens or at least two meshes. Once pre-screened through the mesh, the crushed glass is dried after to at least 100° F., in a preferred embodiment, or to at least 350° F. in another preferred embodiment. Subsequently, the crushed glass is screened through about at least a 20 mesh in a preferred embodiment, or through a 30 mesh in another preferred embodiment, or through a 40 mesh, in yet another preferred embodiment. In still another preferred embodiment, the crushed glass is screened through up to a 150 mesh screen. However, it should be appreciated that in some instances the crushed glass may be a combination of mesh sizes from 20 to 150.

In some preferred embodiments, the oil adsorbed on the glass particles can be further recycled as petroleum silica based product, water repellant product, roof shingles, asphalt, fuel cake or fuel source.

In yet another preferred embodiment, the present invention also provides a method of removing hazardous liquid from a hazardous liquid-containing surface, comprising the step of: applying glass particles to the hazardous liquid containing surface. In this embodiment, the glass particles form clumps with the hazardous liquid at the hazardous liquid-containing surface and the hazardous liquid-glass clumps sink below the top surface of the hazardous liquid; thereby reducing the amount of hazardous liquid on the hazardous liquid-containing surface. In this embodiment, the hazardous liquids can be any hazardous liquids that adhere to the glass particles. In particularly preferred embodiments, the hazardous liquid is a corrosive liquid or a flammable liquid or both. Examples of corrosive liquids include, but are not limited to, acids such as, for example, hydrochloric acid and muriatic acid. Examples of flammable liquids include, but are not limited to, oil, ethylene dichloride, benzene, toluene, ethyl benzene, chlorobenzene, ethyl ketone, naptha and combinations thereof. In those aspects when the fuel is oil, the oil adsorbed on the crushed glass is recycled as petroleum-silica based product, water repellent, roof shingles, asphalt, fuel cake or fuel source. In various exemplary embodiments, the glass particles are glass fiber or crushed glass. When the glass particles are crushed glass, the glass is pre-crushed, pre-screened, dried and screened prior to application on the surface. Preferably, the glass particles are dried so as to substantially remove moisture adhering to the glass particles. However, it should be appreciated that in some embodiments, such as, for example, when an impact crusher or a hammermill crusher is used, the glass does not need to be dried. In various exemplary embodiments, the glass particles are screened from about between 20to 150mesh.

In a preferred embodiment, the present invention also provides an apparatus for removing hazardous liquid from hazardous liquid containing surfaces, comprising an application member and a collection member. The application member is capable of applying glass particles on the surface of the hazardous liquid, whereas the collection member is capable of collecting a hazardous liquid absorbed on the crushed glass. In particularly preferred embodiments, the hazardous liquid is a corrosive liquid or a flammable liquid or both. Examples of corrosive liquids include but are not limited to acids such as, for example, hydrochloric acid and muriatic acid. Examples of flammable liquids include, but are not limited to, oil, ethylene dichloride, benzene, toluene, ethyl benzene, chlorobenzene, ethyl ketone, naptha and combinations thereof. Further, when the glass particles are crushed, the crushed glass is pre-crushed, pre-screened, dried and screened prior to applying the glass particles on the surface. In some preferred embodiments, the crushed glass is screened with at least about a 20 mesh in other preferred embodiments the glass is screened with a 30 mesh, a 40 mesh or up to a 150 mesh. In some exemplary embodiments, the crushed glass is of varying sizes from 20 to 150. In other exemplary embodiments, the crushed glass is dried to substantially remove moisture from the glass particles. In some preferred embodiments, the glass particles are heated to a temperature of at least about 100° F. However, it should be appreciated that the purpose of drying is to substantially remove moisture and thus any drying at whatever temperature (up to the melting point of glass, about 1400° C.) that is adequate to remove such moisture is within the scope of the invention. In addition, those of skill in the art with appreciate that, when the glass is crushed with an impact crusher or a hammermill crusher, moisture adhering to the glass particle is minimal and drying the glass is not necessary. Further, the oil absorbed on the crushed glass is recycled as petroleum-silica based product, water repellent, roof shingles, asphalt, fuel cake or fuel source.

In another preferred embodiment, the present invention provides a method of preventing oil spills from a container having oil, comprising the step of surrounding the oil container at least in part with a layer of glass particles. When the glass particles are crushed, the crushed glass is pre-crushed, pre-screened, dried and screened prior to surrounding the oil container with crushed glass. Preferably, the crushed glass is screened with at least about a 20 mesh. However, in other preferred embodiments, when the glass is crushed it is screened through a 30 mesh, a 40 mesh or up to about a 150 mesh. In some exemplary embodiments, the crushed glass is a mixture of sizes ranging from about a 20 mesh to about a 150 mesh. Also in some preferred embodiments, the glass particles are dried to substantially remove moisture from the glass particles. In some embodiments, the glass particles are dried to a temperature of at least about 100° F. In some preferred embodiments, the oil container is an underground oil storage tank.

In yet another aspect, the present invention provides an apparatus for extinguishing fire from fire containing surfaces. The apparatus comprises an application member, which is capable of applying glass particles on the surface. Preferably, in some embodiments, the application member is an extinguisher cartridge. When the glass particles are crushed glass, the crushed glass is preferably pre-crushed, pre-screened, crushed, dried and screened prior to applying the crushed glass on the surface. In some embodiments, the glass particles are heated to substantially remove moisture from the glass particles. In various preferred embodiments, the glass particles are dried at a temperature of about 100° F. Further, in some preferred embodiments, the glass particles are screened through a 30 mesh, a 40 mesh or up to a 150 mesh. In this embodiment, the fuel source of the fire can be any fuel such as that that would be extinguished using a Class A Extinguisher, a Class B Extinguisher, a Class C Extinguisher, a Class D Extinguisher or a Class K Extinguisher. In this embodiment, the fuel source may include, but is not limited to flammable compounds such as oil, magnesium, lightweight petroleum products and combinations thereof. Further, when oil is the fuel source, the oil absorbed on the glass particles can be further recycled as petroleum silica based product, water repellant product, roof shingles, asphalt, fuel cake or fuel source.

In another preferred embodiment, the invention is a method of preventing fire in an oil container. The method comprises the step of surrounding the oil container, at least in part, with a layer of glass particles. When the glass particles are crushed, the glass is pre-crushed, pre-screened, crushed, dried and screened prior to surrounding the oil container with crushed glass. The crushed glass is screened with at least about a 20 mesh and is dried to substantially remove moisture from the glass particles. In some embodiments, the glass particles are heated to at least about 100° F. However, in some embodiments, the glass is crushed to a 30 mesh, a 40 mesh or up to a 150 mesh. In some preferred embodiments, the oil container is an underground oil storage tank.

The present invention, in general, provides methods and apparatus for extinguishing fire from fire containing surfaces and removing the fuel from the environment. The inventor has previously shown that crushed glass can be used to extinguish oil fires and particularly an oil fire containing surface. See, Arnott et al. U.S. patent application Ser. No. 10/711,328 hereby incorporated in its entirety. The inventor has also shown that crushed glass adsorbs or absorbs the fuel to the surface of the glass, thereby removing the fuel from the fire surface. See, Arnott et al. U.S. Pat. No. 7,041,222 hereby incorporated in its entirety. The inventor has surprisingly found that other glass particles such as glass fiber, commercially available as fiberglass, glass wool or spun glass can also be used to absorb or adsorb the fuel to the glass particles and to extinguish fires resulting therefrom. In use, the glass particles may comprise only crushed glass, only glass fiber or mixtures of the two. Further, as the oil is adsorbed or absorbed to the glass particle surface, the use of glass fiber, which may have a greater surface area then crushed glass, allows for greater adsorption/absorption of the oil. Further, glass has a characteristic melting point ranging from about 1400° C. to about 1600° C. (depending on the composition of the glass); application of glass particles to fires having a hotter burning point results in the glass melting to encapsulate the fuel and thus form an oxygen barrier. In addition, as the fire is put out and the glass cools, it solidifies and hardens, further encapsulating the fuel, decreasing the risk of reignition and increasing the ease of cleanup.

In various exemplary embodiments of the present invention, the glass particle used in extinguishing fire is recyclable glass, non-recyclable glass or glass fiber. In some exemplary embodiments, the glass particles include colored glass; however, in other exemplary embodiments non-colored glass is used. In still other preferred embodiments the glass particle may be a non-crystalline silica compound, such as, for example, Amber Blast™ (Epic Mineral Corp., Neenah, Wis.) or a crushed ceramic. Such ceramic is commercially available such as, for example, pottery pieces or chips, commercially available as, for example, pottery culls (Kohler, Co., Kohler, Wis.). In still other exemplary embodiments, the glass particle may be glass fiber such as that commercially used as insulation. In these embodiments, the glass fiber may be sheared such as that known as loose-fill or spray-in insulation and commercially available as, for example, Spider™ or Climate Pro (Johns Manville, Denver, Colo.) although similar products are commercially available from, for example, Owens Corning (Toledo, Ohio). Further, in various other exemplary embodiments, the glass fiber used may be in rolls known as blankets or batts. Such glass fiber rolls are commercially available from insulation manufacturers including Johns Manville and Owens Corning. Typically glass fibers such as those described above have a diameter of between about 0.55 mm to about 0.77 mm.

A testing of colored crushed glass, which may include a combination or a mixture of recyclable glass, for example, clear or colored beer bottles and chemical containers, indicated that this combination had a chemical content as shown below:

| Sample | pH | Calcium | Magnesium | Sodium | Est. CEC |
|---|---|---|---|---|---|
| 031504A | 9.9 | 4.2 ppm | 0.164 ppm | 108 ppm | 4.461 |
| 031504B | 10.0 | 4.00 ppm | 0.154 ppm | 112 ppm | 4.264 |

A testing of clear crushed glass showed chemical content of crushed glass as below:

| Sample | pH | Calcium | Magnesium | Sodium | Est. CEC |
|---|---|---|---|---|---|
| 403 | 10.3 | 220 ppm | 10 ppm | 83 ppm | 1.245 |

| | |
|---|---|
| 402 | Soluble salts - 16 MHOS × 10⁻⁵ |

The inventor also observed that while both colored and clear glass absorbed oil, clear glass absorbed oil better than colored glass. Without being held to any specific theory, this difference may be accounted by the fact that colored glass has 73 times higher concentration of Sodium as compared to Calcium and Magnesium, as shown below:

[Na]: [[Ca] +[Mg]]:: 0.36:1 for clear glass; and

[Na]: [[Ca] +[Mg]]:: 26:1 for mixed glass,

Increased sodium concentration may enhance oil absorption. While, applicant believes increased oil absorption may be based on sodium concentration, the invention is not limited by this theory, and other reasons may well explain the observed difference in oil adsorption.

In another preferred embodiment, the glass particle includes non-crystalline silica abrasives such as is commercially available under the trade name Amber Blast™ (Epic Minerals, Brookfield, Wis.) or crushed ceramic such as, for example, that referred to as “Pottery Cull” in the art (Kohler Co., Kohler, Wis.). In these embodiments, the non-crystalline silica or ceramic is crushed and screened. In some preferred embodiments, the ceramic or non-crystalline silica is screened through at least about a 20 mesh. However, in other preferred embodiments the silica is screened through a 30 mesh or a 40 mesh or as fine as about 150 mesh. In various exemplary embodiments, the glass particle is crushed to various sizes such that there is a mixture of sizes being screenable through mesh sizes 20 through 150. Chemical analysis of Amber Blast™ shows that it has a chemical composition including:

| Sample | pH | CaO | SiO2 | Al₂O₃ | TiO₂ | MgO | Na₂O |
|---|---|---|---|---|---|---|---|
| Amber Blast ™ | | 37.18% | 35.79% | 18.67 | 4.90 | 1.51 | 0.13% |

In a preferred embodiment, the glass particles are crushed using an impact crusher, hammer mill, cone crusher or a roller crusher. In some preferred embodiments, the glass particles are crushed using roller crusher. However, the inventor has further observed that, in some embodiments, better oil adsorption occurs when the glass is crushed using a roller crusher. However in other preferred embodiments an impact crusher is used. When an impact crusher or hammermill crusher is used, it is generally, not necessary to dry the crushed glass as moisture is dissipated in the crushing apparatus. Thus, it should be appreciated by those of skill in the art that the purpose of heating the glass particles is to substantially remove the moisture. Therefore, heating the glass particles at any temperature up to the melting point of glass (approximately 1400° C., depending on the class composition) is encompassed by the invention.

Any order of pre-crushing, pre-screening, crushing, and drying may be used. In a preferred embodiment however, the crushed glass is first pre-crushed and pre-screened, as necessary. If the glass is clean, no pre-crushing or pre-screening is required. The pre-crushed glass is pre-screened through a mesh, which may include an inch mesh, a combination of double or triple deck screens or at least two meshes. Once pre-screened through the mesh, the glass is further crushed using a roller crusher and subsequently, the crushed glass is dried after to at least 100° F. in a preferred embodiment, or to at least 350° F. in another preferred embodiment. Subsequently, the crushed glass is screened through at least about a 20 mesh, in a preferred embodiment, or through about a 30 mesh in another preferred embodiment, or through about a 40 mesh, in yet another preferred embodiment. In other preferred embodiments, the glass may be screened to as fine as about 150 mesh. In some embodiments the glass may have a variety of sizes ranging from screenable through about a 20 mesh through about a 150 mesh. In addition, the inventor has further observed that when an impact crusher or hammermill crusher is used to crush the glass particles, the particles do not require drying.

Generally 150, 40, 30, 20 mesh imply about 150×150, 40×40, 30×30 and 20×20 number of wires running along a vertical and horizontal axis, per inch. Therefore an inch mesh would indicate that each grid of the mesh is 1″×1″, or 40 mesh would indicate that each grid is 1/40″× 1/40″ in width and length. For 40 mesh, the wire diameter is about 0.01″. Such meshes are commercially available as single, double or triple decked screens. For, example, such meshes are commercially available at Twin City Wire, Minn. Further, the oil absorbed on the glass particles is recycled as petroleum-silica based product, water repellent, roof shingles, or asphalt.

In a preferred embodiment, the present invention also provides a method of removing oil from oil containing surfaces, comprising the step of applying glass particles to the surface, whereby the quantity of oil is reduced from the surface. In this embodiment, the glass particles are pre-crushed, pre-screened, crushed, dried and screened prior to application on the oil containing surface. Preferably, the crushed glass is dried to a temperature of at least about 100° F. In other embodiments the glass particles are heated to about 200-350° F. Also preferably, the crushed glass is screened with a mesh selected from about a 20 mesh up to at least about 150 mesh.

In one preferred embodiment, the present invention also provides an apparatus for removing oil from oil containing surfaces, comprising an application member and a collection member. The application member may include a nozzle for spraying glass particles. Wider nozzles may be used to cover greater surface area of application. Generally, the application member is capable of applying glass particles on the surface, whereas the collection member is capable of collecting oil absorbed on the glass particles. In this embodiment, the application member may be any member capable of spraying glass particles on a surface. Examples of such application members include, but are not limited to, pressurized application members such as are generally referred to as fire extinguishers. In other versions, the application member may be more robust, more similarly resembling devices commercially available such as pressure blasters (Kramer Industries, Inc. Piscataway, N.J.). The collection members may include altered fishing nets, with reduced net size, large wired receiving baskets or any organic or inorganic net, such as steel wire or polymer based nets for receiving clumps of oil-glass particle mixtures. Once the clumped mixtures are retrieved they may be recycled in any desirable way. In one embodiment, more glass particles may be added to alter the consistency of the clump, which may be then recycled as asphalt. In some exemplary embodiments, the glass particles are pre-crushed, pre-screened, crushed, dried and screened before applying the glass particles on the surface. When crushed, the glass particles are screened with at least about a 20 mesh. Also, preferably, the crushed glass is dried to a temperature of about at least 100° F. In other embodiments the glass particles are heated to about 200-350° F. Further, the oil absorbed on the crushed glass is recyclable as petroleum-silica based product, water repellent, roof shingles, or asphalt. However, it should be noted that, in some preferred embodiments, when the glass particles are glass fibers, the glass fibers do not need to be crushed and may be used to adsorb/absorb oil either as batts that are spread over the oil containing surface or as sheared glass fibers such as glass wool or blowable fiberglass insulation. When batts are used, the batts can be any thickness suitable to absorb the oil. In these embodiments, the glass fiber can be blown over the oil containing surface with a blower similar to that used to blow the fiber when used as insulation. In these embodiments, when the glass particle is glass fiber, the glass particles do not need to be dried. However, it should be understood that the purpose of drying is to substantially remove moisture that would inhibit the oil from adhering to the glass particle. In such cases, drying the glass particles does not hinder the glass particle from adsorbing the oil.

Other well known techniques, such as aerial dropping (via helicopter, airplane, balloon or such) of fire retardants, known to one of ordinary skill in the art may also be used for dispersing the glass particles on a desired surface to remove oil.

In another preferred embodiment, the present invention provides a method of preventing oil spills from a container having oil, comprising the step of surrounding the oil container at least in part with a layer of glass particles. In those embodiments when the glass particles are crushed, the glass particles are pre-crushed, pre-screened, crushed, dried and screened prior to surrounding the oil container with glass particles. Preferably, the crushed glass is screened with at least about a 20 mesh. Also preferably, the crushed glass is dried to a temperature about 200-350° F. In a preferred embodiment, the oil container is an underground oil storage tank. Other underground or over the ground containers are also contemplated. Other uses also include surrounding oil tankers in the high seas and river at least in part with crushed glass.

Another aspect of the invention provides a method of extinguishing fire from fire containing surfaces. The method comprises the step of applying glass particles to the surface, whereby the intensity of fire is reduced from the surface. The surface includes oil topped surfaces, magnesium topped surfaces, water containing oil, saline water containing oil, earth, ground, dirt, mud gravel, land surrounding water bodies, sand, seashore, estuary, bay or gulf, oceans, lakes or rivers. Further, flammable compounds which may comprise fuel on such fire containing surfaces may include, oil, magnesium, lightweight petroleum products and combinations thereof. When glass particles are crushed, they are crushed using an impact crusher, hammer mill, cone crusher or a roller crusher. In some preferred embodiments, the crushed glass is crushed using a roller crusher. During processing, the crushed glass is pre-crushed and pre-screened. In some preferred embodiments, the crushed glass is colored glass. In some embodiments, the crushed glass may be further crushed and screened through at least one mesh, such as an inch mesh or at least two meshes. The crushed glass is dried to at least 100° F. after screening through the mesh. Preferably, the crushed glass is dried to at least 350° F. The crushed glass is further screened through about a 20 mesh, 30 mesh, 40 mesh or up to about 150 mesh. In these embodiments, the glass may be a mixture screened to as fine as a 150 mesh. The by product of the fire extinguishing process creates oil-glass mixture clumps, which is further recycled as petroleum silica based product, water repellant product, roof shingles, asphalt, fuel cake or fuel source.

It should be noted magnesium fires extremely hot and difficult to extinguish. For this reason, the National Fire Protection Association (NFPA) recommends stringent handling conditions to segregate magnesium from other combustible material. The methods disclosed herein provide significant improvement over previous methods of extinguishing magnesium fires. For example, magnesium fires are extremely hot burning at 4000° F. Burning magnesium reacts violently with water to form hydrogen, an extremely flammable gas as well as producing toxic fumes. In addition, once ignited, magnesium can burn in nitrogen (forming magnesium nitride) and in carbon dioxide (forming magnesium oxide and carbon). Recommended methods of extinguishing magnesium fires require use of a class D dry chemical fire extinguisher or sand. However, as disclosed herein, when the methods according to the invention are used to extinguish magnesium fires, the glass particles provide hitherto unrecognized advantages over prescribed methods of extinguishing magnesium fires. First, the glass particles form an atmospheric barrier smothering the fire. Second, because the magnesium fire is so hot, the glass begins to melt, thereby further covering the magnesium metal and coating the metal with liquid glass thereby decreasing the flammability of the fire. Third, as the magnesium fire is smothered and the heat decreases, the glass begins to solidify thereby encasing the metal in glass and inhibiting reignition of the metal. These are characteristics not generally available using conventional magnesium fire extinguishers. Further, using the glass particles as described herein limits the need to use chemicals inherent in class D extinguishers.

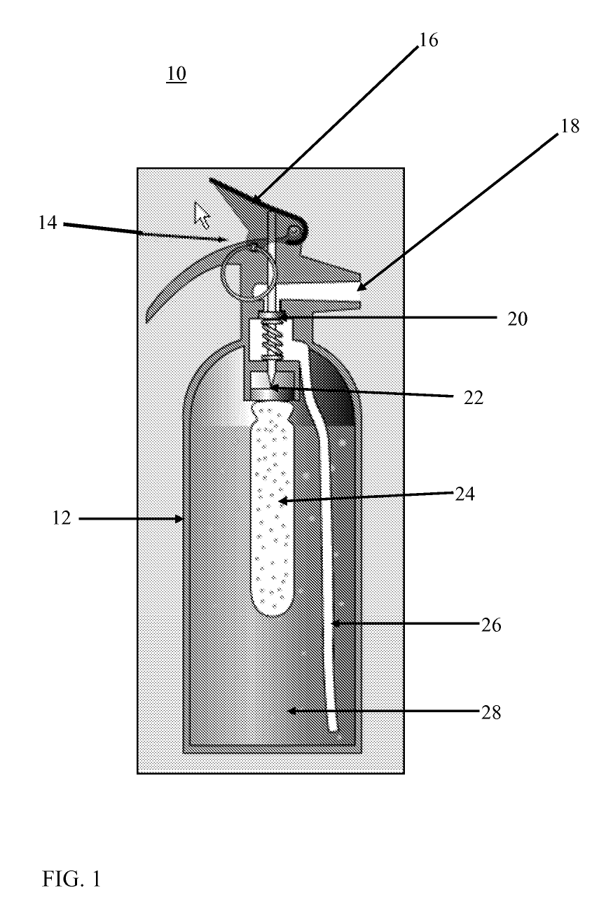

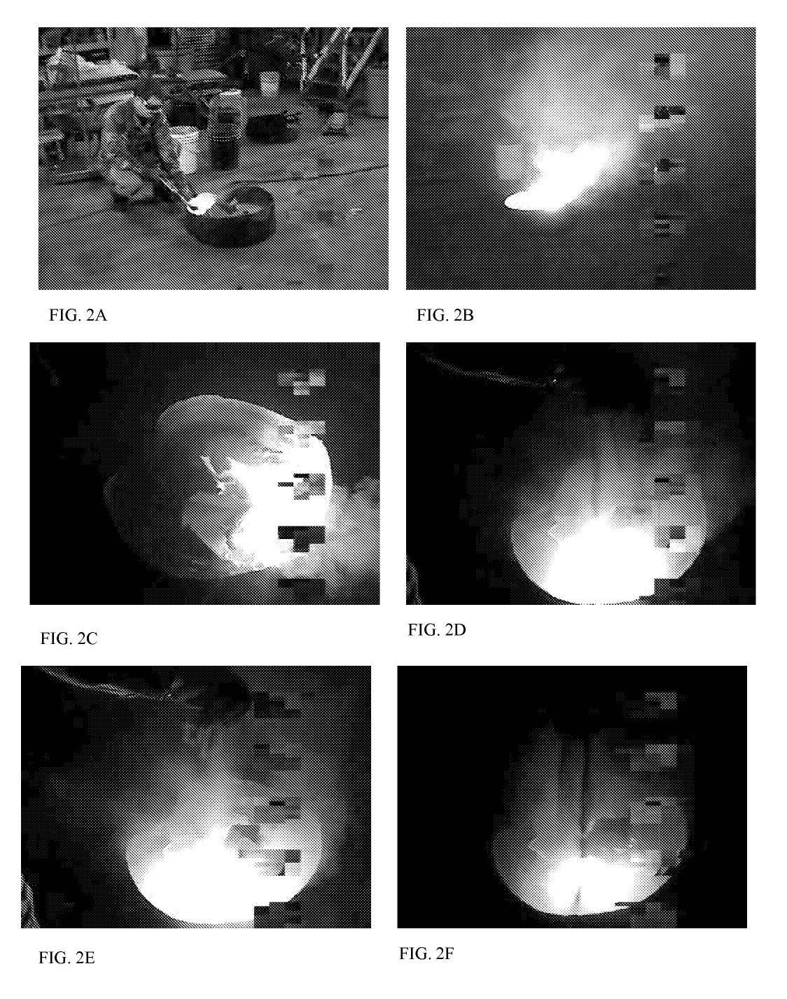

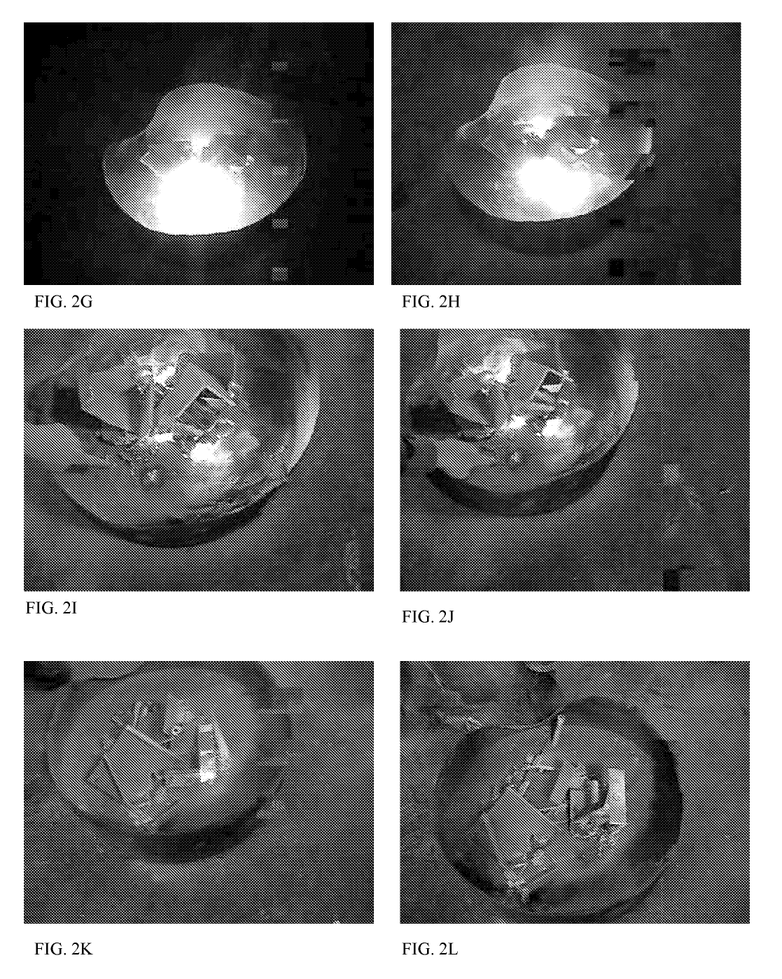

In yet another embodiment, the present invention provides an apparatus for extinguishing fire from fire containing surfaces. The apparatus comprises an application member, which is capable of applying glass particles on the surface. In this embodiment, the fuel can be any flammable compound such as, for example, oil, magnesium, lightweight petroleum products and combinations thereof. In some preferred embodiments, the application member is an extinguisher cartridge. One version of this embodiment is shown in FIG. 1. In this embodiment, the fire extinguishing apparatus 10 may resemble a conventional fire extinguisher. As shown, the extinguishing apparatus 10 has a containing 12, a pin 14, a handle 16, a nozzle 18, a first valve 20, a second valve 22, a cartridge 24, a siphon tube 26 and a suppressant 28. In a preferred embodiment, cartridge 24 is loaded with glass particles. However, it should be appreciated that, the fire extinguishing apparatus can be any apparatus that is capable of dispersing glass particles over the fire containing surface. For example, such apparatus as pressure blasters (Kramer Industries, Piscataway, N.J.) could be used. In some versions, glass particles used in the apparatus are preferably pre-crushed, pre-screened, crushed, dried and screened prior charging the cartridge with the particles applying the glass particles on the surface. The crushed glass is screened with about at least a 20 mesh up to about a 150 mesh. In some embodiments, the glass particles are dried to substantially remove moisture. In various exemplary embodiments, the glass particles are dried at a temperature of above about 100° F. to about 2500° F. (the melting point of glass). In other embodiments, the glass particles are dried to a temperature about 200-350° F. However, it should be appreciated that the step of drying is to remove moisture from the glass particles, thus any substantially dry glass particles are encompassed by the invention. Further, when the glass particles are crushed in a hammermill or impact crusher the glass particles may not have moisture adhering thereto. The oil absorbed on the glass particles can be further recycled as petroleum silica based product, water repellant product, roof shingles, asphalt, fuel cake or fuel source.

In another embodiment, the method according to this invention comprises a method of preventing fire in an oil container. The method comprises the step of surrounding the oil container at least in part with a layer of glass particles. When the glass particles are crushed, the crushed glass is pre-crushed, pre-screened, crushed, dried and screened prior to surrounding the oil container with crushed glass. The crushed glass is screened with about a 20 mesh and up to a 150 mesh and is dried at a temperature about 100° F. In other embodiments, the glass particles are dried at a temperature of about 200-350° F. In some preferred embodiments, the oil container is an underground oil storage tank.

The following examples illustrate the use of glass particles for extinguishing fire, removing hazardous liquids from a surface, removing oil and containing fire. These examples are for illustration only and should not be deemed to limit the scope of the invention.

### EXAMPLE I

### Glass Particles do not Absorb Water

Colored crushed glass, screened through 40 mesh was applied on clean water, without oil. The crushed glass was applied on the water surface until it sank. The water was poured out from the container and the crushed glass was removed after about an hour. The crushed glass was observed and it was determined that the crushed glass did not absorb water for up to three days.

### EXAMPLE II

### Glass Particles Adsorb Oil from Water and Form Aggregate that Does not Leach

Oil was poured in a tank containing water to simulate an oil spill. Crushed glass was applied on the surface of the oil spill. The crushed glass noticeably adsorbed the oil and sank to the bottom of the tank in a clump. The water from the tank was emptied out. The crushed glass-oil mixture came out bonded together. More crushed glass was added to the crushed glass-oil mixture and was removed. Adding additional glass formed a ball with a petroleum base, which may be further recycled and used for other purposes. Such as, for example, petroleum silica based product, water repellant product, roof shingles, asphalt, fuel cake or fuel source.

### EXAMPLE III

### Glass/Oil Aggregate is Inert and Does not Leach Waste

Oil was poured in a tank containing water to simulate an oil spill. Colored screened crushed glass was applied on the surface of the oil spill. The crushed glass noticeably adsorbed the oil and sank to the bottom of the tank in a clump. The crushed glass-oil mixture clump was left to sit on the bottom of the water tank for about three months. The crushed glass-oil mixture was still clumped together and the water above it was clear. Water did not get into the clump.

### EXAMPLE IV

### Glass Particles Adsorb Complex Oil Spill

Oil was poured in a tank containing water to simulate an oil spill. Various petroleum products such as motor oil, transmission oil, hydraulic oil, gasoline and thinners were used. Crushed glass screened through 40 mesh was applied on the surface of the oil spill. The crushed glass noticeably adsorbed the oil and sank to the bottom of the tank in a clump. Other mesh sizes were used; however, best results were obtained by 40 mesh.

### EXAMPLE V

### Differential Absorption by Glass

Oil was poured in a tank containing water to simulate an oil spill. Glass was crushed using an impact crusher and a roller crusher. The crushed glass was applied on the water surface until it sank. Impact crushed glass appeared to adsorb more water when emptied into clean water, which later turned into mud. The glass crushed with the roll crusher adsorbed oil better than glass crushed by an impact crusher. This may be because glass becomes more porous upon impact from the impact crusher. However, the use of an impact crusher or hammermill crusher should remove the need to heat the crushed glass because less moisture is introduced into the glass and the moisture present is removed during the impacting process.

### EXAMPLE VI

### Differential Glass Characteristics in Water

Mixed-colored and clear crushed glass coming out of the dryer at the same temperature was separately applied on a water surface until they sank. When clear crushed glass was applied to a clean tank of water, it appeared to absorb water and turn into mud.

### EXAMPLE VII

### Oil Preferentially Adheres to Glass and Does not Leach into Substrate

Oil was poured in a tank containing sand and water to simulate an oil spill. Crushed glass was applied to the surface of the water containing oil. The crushed glass adsorbed oil and sunk. Oil sinking to the bottom of a sand water bed was tested. After allowing the crushed glass-oil mixture to sit in the water tank for one week, the water was dumped and the glass-oil mixture was allowed to sit for another week on the sand bed. The oil adsorbed in the crushed glass did not appear to penetrate the sand bed substrate.

### EXAMPLE VIII

### Glass Particles Extinguish Oil Fire

5 gallons of waste oil weighing approximately 35 lbs was put in a cut 55 lb barrel approximately 24″ in diameter and 12″ high. The oil was set on fire and was allowed to burn for 3 minutes. Three handfuls (approximately 3 lb) of fine crushed glass, 30-40 mesh size was hand tossed on the burning fire. Oil—glass mixture clumps sank to the bottom of the barrel and the fire was completely put off in about 40 seconds. After the fire had been extinguished, the oil weighed about 30 lbs, i.e. only about 5 lbs of oil was burned.

### EXAMPLE IX

### Oil is Retrieved from Glass/Oil Aggregate

The oil-glass clump mixture from EXAMPLE VIII was retrieved and pressed on a 1″ steel plate using a 50 ton press. Upon pressing, the oil separated from in between the steel plates. This separated oil is available for further recycling into any desirable product.

### EXAMPLE X

### Fuel Adsorbed to Glass is a Fuel Source

1 lb of fuel glass was adsorbed on 4 lb 8 oz of powdered glass of about 40 mesh. This fuel cake was allowed to burn for 60 minutes and temperature was subsequently monitored to estimate the duration of burning and quality of the fuel cake as shown in the table below:

| Temperature in ° F. | Time in minutes |
|---|---|
| 885 | 10 |
| 894 | 15 |
| 779 | 20 |
| 835 | 25 |
| 841 | 30 |
| 793 | 35 |
| 616 | 45 |
| 730 | 50 |
| 350 | 55 |

After about an hour the flame went out and the remaining residue weighed about 4lb. Indicating substantially complete combustion of the oil adhered to the glass. However, Applicant estimates that under proper ventilation, the fire could have burned to a longer duration. It will be obvious to those of skill in the art that the oil adsorbed glass provides a fuel cake or fuel source that can be conveniently used, such as for example Sterno® is used. Further, unused glass may be further recycled to adsorb more oil.

### EXAMPLE XI

### Use of Apparatus to Extinguish Kitchen Fire

An experiment was carried out to test putting off fire using glass particles on a simulated commercial kitchen fire, using restaurant grease. A 10 lb CO₂ cartridge of a fire extinguisher was filled with 10 lbs of glass particles crushed to about a 40 mesh. The grease fire was ignited and was allowed to bum for about 3 minutes. Using the glass in the fire extinguisher, the fire was put off in about 3 seconds.

### EXAMPLE XII

### Use of Apparatus to Extinguish Oil Fire

A further experiment was performed using the above described process to put off waste oil fire. After about 5 seconds of applying the glass particles from the extinguisher cartridge, the second fire was also put out. Both experimental runs produced minimal mess and minimal collateral damage. This is especially advantageous for commercial kitchens, in that the restaurant does not have to be closed down for long durations for cleaning. Further, glass is 100% recyclable and is non toxic and does not leave tracks as chemical extinguishers, saving carpets and other outer areas.

### EXAMPLE XIII

### Glass Particles Remediate Corrosive Liquids—Large Batch

An experiment was performed to determine the efficacy of using glass particles to remediate spilled corrosive liquids. In this experiment, approximately 3 pounds of glass particles was used to adsorb about eight ounces of muriatic acid. The glass particles and muriatic acid aggregated into a ball and was put in water overnight. Upon examination the next day, the glass particles and muriatic acid remained clumped.

### EXAMPLE XIV

### Glass Particles Remediate Corrosive Liquids—Small Batch

An experiment was performed to determine the efficacy of using glass particles to remediate spilled corrosive liquids. In this experiment, approximately 1.5 pounds of glass particles was used to adsorb about eight ounces of muriatic acid. The glass particles and muriatic acid aggregated into a ball and was put in water overnight. Upon examination the next day, the glass particles and muriatic acid remained clumped and little had leached into the water. There was no difference in the ability of glass particles to adsorb acid when used at either the 3 pound or 1.5 pound concentration.

### EXAMPLE XV

### Use of Glass Particles to Extinguish Heptane Fire

Glass particles were applied to the surface of a heptane, paint thinner fire. 16 hours after the fire was extinguished the glass mixture was put under water in a sealed container and left for four days. After four days only a trace residue of heptane floated on top of the water. This indicates that the heptane does not become dissociated from the glass particle aggregate even after prolonged submersion in water. The glass mixture was taken out of the water and lit with a match to confirm the presence of flammable heptane accreted to the glass mixture. This example illustrates: 1) that once the oil is adsorbed to the surface of the glass particle it does not dissociate even when stored in water; 2) even when stored under water, the oil adsorbed to the glass particle is chemically unchanged and is still available as a fuel source; and 3) water does not infiltrate the glass/fuel aggregate.

### EXAMPLE XVI

### Absorption of Oil Using Spun Glass Batt

While previous examples have illustrated the use of glass particles in absorbing oil from a water/oil mixture resulting in the formation of an aggregate that sinks, the inventor has further found that fiber glass or spun glass can also be used to absorb oil. In this experiment, a batt of fiberglass approximately 3 inches thick (such as is commercially available, Corning Inc., Corning, N.Y.) was applied to the fire containing water surface. The fiberglass rapidly absorbed the oil from the surface and then sank removing the oil from the oil containing surface. In this embodiment, after the fiberglass sank, it could be recovered, the fiberglass rolled into a ball and the ball squeezed by a press to removed the absorbed oil.

### EXAMPLE XVII

### Absorption of Oil Using Sheared Spun Glass

In this experiment, a 3′×3′ piece of fiberglass batting (about one pound) was put in a food processor and sheared. A container having approximately two liters of oil was ignited and after a few minutes the sheared spun glass was applied. The fire was extinguished and the sheared spun glass absorbed the remaining oil. The sheared spun glass was then rolled into a ball and pressed in a press to recover the oil.

### EXAMPLE XVIII

### Use of Ceramic to Extinguish Fire

Other forms of glass, such as ceramic and crystalline silica materials were tested for their efficacy in putting out fires. The inventor has found that crushed ceramic particles (ceramic cull, Kohler Co., Kohler, Wis.) and non-crystalline silica abrasive materials such as, for example AMBER BLAST™ (EPIC MINERALS, Brookfield, Wis.) are also effective in extinguishing fires. In this experiment, approximately 2 quarts of oil was placed in a shallow container and the oil was ignited. Approximately two pounds finely crushed ceramic was deposited on the fire. The fire was extinguished and the remaining oil was adsorbed to the crushed ceramic particles and aggregated to form a ball.

### EXAMPLE XIX

### Use of Non-Crystalline Silica to Extinguish Fires

In another experiment, approximately 4 pounds non-crystalline silica (Amber Blast™) particles were crushed, ground and screened through 40 mesh screen. Approximately 2 quarts of oil was placed in a shallow container and ignited. The crushed non-crystalline silica was put on the fire and the fire was extinguished. The remaining oil was adsorbed to the non-crystalline silica and aggregated to form a ball.

### EXAMPLE XX

### Use Of Glass Particle to Extinguish Magnesium Fire

In this experiment, approximately three pounds of magnesium scrap metal was placed in a cut 55 gallon drum having a height of about 12 inches. The magnesium was ignited with a blow torch. After several minutes, the magnesium fire was white hot and covered all the metal. Approximately 3 handfuls of glass particles were deposited over the magnesium fire. The flames were extinguished. Regions of glass particles on the fire became darker as the glass melted to a liquid. The liquid glass ran into the pores and surface features of the magnesium scrap. After several minutes the darker areas of glass lightened in color and the glass returned to a solid. The fire was extinguished.

The methods, compositions and apparatus for removing oil and extinguishing oil fires of the present invention may have other applications aside from use in oil spills and hazardous fires such as oil and magnesium. Thus, although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims.

What is claimed is:

1. A method of extinguishing fire from a fire containing surface, comprising the step of applying glass particles to the fire containing surface, wherein the glass particles form clumps with the fuel at the fire-containing surface and the fuel-glass clumps sink below the top surface; thereby reducing the intensity of the fire from the fire containing surface or effectively extinguishing the fire from the fire containing surface.

2. The method of claim 1, wherein the fuel is selected from the group consisting of: oil, magnesium, heptane and combinations thereof.

3. The method according to claim 1, wherein the glass particles are selected from the group consisting of finely crushed glass, glass fiber and combinations thereof.

4. The method of claim 3, wherein, when the glass particles are finely crushed glass, the finely crushed glass is formed by the process of crushing glass using an impact crusher, hammer mill, cone crusher or a roller crusher.

5. The method according to claim 3, wherein the finely crushed glass is screened using at least one mesh.

6. The method according to claim 3, wherein the finely crushed glass is dried at about 100° F. or greater.

7. The method according to claim 3, wherein the finely crushed glass is colored glass, clear glass, non-crystalline silica abrasive or ceramic.

8. The method according to claim 3, wherein the glass particles are mixed with: monoammonium phosphate; ammonium sulphate; mica; fullers earth; silicone oil; calcium carbonate; amorphous silica; sodium chloride, mica; attapulgite clay; mineralite; magnesium stearate; potassium bicarbonate; mica; attapulgite clay and silicone oil, diammonium phosphate, alkyl acid phosphates, sodium chloride, magnesium stearate, sodium bicarbonate, magnesium aluminum silicate, diethylene glycol monobutyl ether, tertiary butyl alcohol, hexylene glycol, ethylene glycol and combinations thereof.

9. A method according to claim 3, wherein the crushed glass is screened through at least two meshes.

10. A method according to claim 3, wherein the finely crushed glass is further screened through a 150 mesh, 40 mesh, 30 mesh or 20 mesh.

11. The method according to claim 3, wherein the glass fiber is fiberglass or spun glass.

12. A method according to claim 2, wherein the oil adsorbed to the glass particle is further recycled as petroleum silica based product, water repellant product, roof shingles, asphalt, fuel cake or fuel source.

13. An apparatus for extinguishing fire from fire containing surface, comprising:
(a) a container, having a cavity and an opening thereto;
(b) an application member, secured in the opening, the application member comprising:
(i) a security pin, (ii) a handle, (iii)a nozzle, (iv) a first valve, (v) a second valve,
(vi) a cartridge, (vii) a siphon tube and (viii) a suppressant,
(c) wherein the cartridge contains glass particles useful in extinguishing fire from a surface.

14. The apparatus according to claim 13, wherein the glass particles are pre-crushed, pre-screened, crushed, dried and screened prior to applying the glass particles on the surface.

15. The apparatus according to claim 13, wherein the glass particles are screened with a 20 mesh, 30, mesh, 40 mesh, 150 mesh or combinations thereof.

16. The apparatus according to claim 14, wherein the glass particles are dried to substantially remove moisture prior to loading in the cartridge.

17. The apparatus according to claim 16, wherein the glass particles are dried at about 100° F. or higher.

18. The apparatus according to claim 13, wherein oil absorbed on the glass particles is further recycled as petroleum silica based product, water repellant product, roof shingles, asphalt, fuel cake or fuel source.

19. The apparatus according to claim 13, wherein the glass particles are mixed with: monoammonium phosphate; ammonium sulphate; mica; fullers earth; silicone oil; calcium carbonate; amorphous silica; sodium chloride, mica; attapulgite clay; mineralite; magnesium stearate; potassium bicarbonate; mica; attapulgite clay and silicone oil, diammonium phosphate, alkyl acid phosphates, sodium chloride, magnesium stearate, sodium bicarbonate, magnesium aluminum silicate, diethylene glycol monobutyl ether, tertiary butyl alcohol, hexylene glycol, ethylene glycol and combinations thereof.

20. A method of removing a hazardous liquid from a hazardous liquid-containing surface, comprising the step of: applying glass particles to the hazardous liquid containing surface, wherein the glass particles form clumps with the hazardous liquid at the hazardous liquid-containing surface and the hazardous liquid-glass clumps sink below the top surface of the hazardous liquid; thereby reducing the amount of hazardous liquid on the hazardous liquid-containing surface.

21. The method of claim 20, wherein the hazardous liquid is selected from the group consisting of: oil, corrosive liquid and combinations thereof.

22. The method of claim 21, wherein the corrosive liquid is an acid

23. The method of claim 20, wherein the glass particles are dried to substantially remove moisture before applying.

24. The method of claim 20, wherein the glass particles are dried to a temperature of about 100° F. or higher.
